(19) United States
(12) Patent Application Publication
(10) Pub. No.: US 2016/0286275 A1
(43) Pub. Date: Sep. 29, 2016

(54) CONTENT DELIVERY SYSTEM, DELIVERY PROGRAM, AND DELIVERY METHOD

(71) Applicant: DENA CO., LTD., Tokyo (JP)

(72) Inventors: Yuji MAEDA, Tokyo (JP); Yasunobu SASAKI, Tokyo (JP)

(21) Appl. No.: 15/033,428

(22) PCT Filed: Aug. 7, 2014
(86) PCT No.: PCT/JP2014/070853

§ 371 Date: Apr. 29, 2016

(30) Foreign Application Priority Data
Nov. 5, 2013 (JP) 2013-229386

(51) Int. Cl. H04N 21/478; G06Q 30/06; H04N 21/431

(52) U.S. Cl. CPC H04N 21/47815; H04N 21/4312; G06Q 30/0643; G06Q 30/0631

(57) ABSTRACT

One object is to provide a content delivery system, a delivery program, and a delivery method that can prompt the viewing users to obtain or purchase items. The system according to an embodiment of the present invention includes: a reception unit configured to receive from each of the plurality of users a display request for a display item selected from items purchased by the user; a display position determination unit configured to determine display positions of avatars of the plurality of users based on the display requests from the users; and a display control unit configured to cause a client of each of the plurality of users to display a view including the content, an image representing the display item, and images representing the avatars of the users such that the avatars of the users are displayed at the display positions determined by the display position determination module.

### TECHNICAL FIELD

### CROSS-REFERENCE TO RELATED APPLICATIONS

This application is based on and claims the benefit of priority from Japanese Patent Application Serial No. 2013-229386 (filed on Nov. 5, 2013), the contents of which are hereby incorporated by reference in their entirety. The present disclosure relates to a content delivery system, a delivery program, and a delivery method, and in particular to a content delivery system, a delivery program, and a delivery method that can facilitate purchase of items.

### BACKGROUND

There has been known a content sharing system for distributing contents such as a posted concert video to many users. An example of such a content sharing service is disclosed in Japanese Patent Application Publication No. 2012-120098 (Patent Literature 1). Patent Literature 1 discloses displaying, around a content screen, an image of an item (e.g., an image representing a flower bouquet) purchased by a user viewing the content (hereinafter also referred to as “viewing user”) in accordance with a request from the viewing user, so as to decorate the content screen. Such an image of a decorative item is displayed not only in the viewing screen of the user who requested the display but also in the viewing screen of other users. Thus, the system of Patent Literature 1 can produce a cheerful atmosphere supporting the content (or the posting user thereof), in addition to simply delivering the content.

The decorative items are purchased for value by viewing users to express positive evaluation of the posting user or the performer of the content. When the content is obtained or purchased for value, a positive evaluation is communicated to the posting user of the content, which supports the creative activity of the posting user. When the content is purchased for value, a part of the charge may be delivered to the posting user of the content. Purchasing an item and displaying an item in association with a content by a user leads to supporting the creative activity of the posting user of the content. Richness in quality and amount of posted contents is an important factor of the content sharing service. It is desirable to prompt the users to purchase items so as to sufficiently support activity of creating contents.

### RELEVANT REFERENCES

### List of Relevant Patent Literature

Patent Literature 1: Japanese Patent Application Publication No. 2012-120098

### SUMMARY

However, conventional content sharing services do not have a setup for prompting the users to obtain or purchase items. To overcome this problem, one object of the present invention is to provide a content delivery system, a delivery program, and a delivery method that can prompt the viewing users to obtain or purchase items. Other objects of the invention will be apparent with reference to the entire description in this specification.

One embodiment of the present invention relates to a system comprising one or more computer processors for executing a computer program to provide a content to each of a plurality of users. The computer program according to an embodiment of the present invention comprises: a reception module configured to receive from each of the plurality of users a display request for a display item selected from items purchased by the user; a display position determination module configured to determine display positions of avatars of the plurality of users based on the display requests from the users; and a display control module configured to cause a client of each of the plurality of users to display a view including the content, an image representing the display item, and images representing the avatars of the users such that the avatars of the users are displayed at the display positions determined by the display position determination module. As is obvious from the above description, the system according to an embodiment of the present invention causes the one or more processors to execute the modules described above and described later and serve as: a reception unit configured to receive from each of the plurality of users a display request for a display item selected from items purchased by the user; a display position determination unit configured to determine display positions of avatars of the plurality of users based on the display requests from the users; and a display control unit configured to cause a client of each of the plurality of users to display a view including the content, an image representing the display item, and images representing the avatars of the users such that the avatars of the users are displayed at the display positions determined by the display position determination module.

According to the embodiment, the display positions of the avatars of the users may be determined in accordance with the display requests for the display items selected from the items purchased by the users. Therefore, the display positions of the avatars of the users in the view are correlated with the display items for which the users made display requests and the items purchased by the users. Accordingly, the users can grasp which user made more display requests, and furthermore, which user purchased more items. Thus, the esteem needs of the users or the rivalry between the users may urge the users to purchase items.

Simply “purchasing” an item herein includes both purchasing the item for value and obtaining the item free of charge. “Purchasing for value” or other similar phrases are used for purchasing for value, whereas “purchasing free of charge,” “obtaining,” or other similar phrases are used for purchasing free of charge. Simply “obtaining” an item herein refers to obtaining an item free of charge. When an item is obtained for value, the item is obtained by paying (or consuming) a counter value such as real currency, virtual currency, in-game points, and points used in other services, as will be described later.

The display position determination module according to an embodiment of the present invention may determine the display positions of the avatars of the users such that as the purchase quantity or purchase amount of the display item is larger, the avatars of such users are displayed closer to the display position of the content. Thus, the users can more clearly grasp which user made more display requests (and as a premise, which user purchased more items) based on the relationship between the positions of the content and the avatars of the users. That is, the users can grasp that the user corresponding to the avatar positioned close to the contents viewed has made the most display requests and, as a premise, has purchased many items. Therefore, the users may be motivated to purchase more items so as to have the avatars thereof displayed at display positions provided to users having made a display request for more items.

The computer program according to an embodiment of the present invention further comprises a ranking generation module configured to generate a ranking of the plurality of users related to a purchase quantity or purchase amount of the display item. In an embodiment of the present invention, the image of the content may be generated so as to include the ranking generated by the ranking generation module. Thus, the purchase quantity and purchase amount of items may be presented to the users in a clearer form, and therefore, the users may be further urged to purchase items.

The determination module according to an embodiment of the present invention may be configured to determine the display positions of the avatars of the users based on the display requests made within a predetermined period. In an embodiment of the present invention, the view may include the ending time of the predetermined period used for determination of the display positions of the avatars. Thus, the users may be urged to purchase the items before the ending time.

An embodiment of the present invention relates to a computer program for providing a particular content to each of a plurality of users. The computer program according to an embodiment of the present invention may cause one or more computer processors to serve as: a reception means configured to receive from each of the plurality of users a display request for a display item selected from items purchased by the user; a display position determination means configured to determine display positions of avatars of the plurality of users based on the display requests from the users; and a display control means configured to cause a client of each of the plurality of users to display a view including the content, an image representing the display item, and images representing the avatars of the users such that the avatars of the users are displayed at the display positions determined by the display position determination module.

An embodiment of the present invention relates to a method for providing a particular content to each of a plurality of users. The method according to an embodiment of the present invention comprises: receiving from each of the plurality of users a display request for a display item selected from items purchased by the user; determining display positions of avatars of the plurality of users based on the display requests from the users; and causing a client of each of the plurality of users to display a view including the content, an image representing the display item, and images representing the avatars of the users such that the avatars of the users are displayed at the display positions determined by the display position determination module.

Various embodiments of the present invention provide a content delivery system, a delivery program, and a delivery method that can prompt the viewing users to obtain or purchase items.

### BRIEF DESCRIPTION OF THE DRAWINGS

FIG. 1 is a block diagram schematically illustrating a content delivery system according to an embodiment of the present invention.

FIG. 2 shows an example of purchase history management table according to the embodiment of the present invention.

FIG. 3 shows an example of display item management table according to the embodiment of the present invention.

FIG. 4 shows an example of a view generated in accordance with an embodiment of the present invention.

FIG. 5 shows an example of a view generated in accordance with an embodiment of the present invention.

FIG. 6 is a flow diagram showing a process flow from start of viewing a content to display of a view including the content and avatars.

### DESCRIPTION OF EXAMPLE EMBODIMENTS

Various embodiments of the present invention will be described hereinafter with reference to the drawings. In the drawings, the same components are denoted by the same reference numerals.

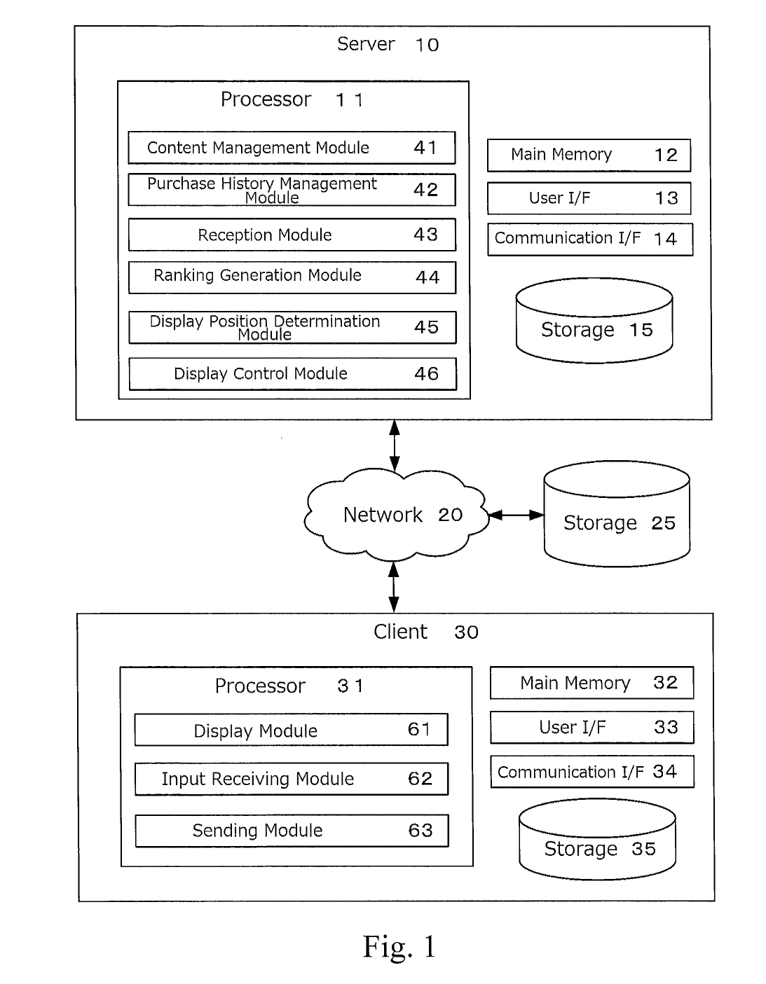

FIG. 1 is a block diagram schematically illustrating a system according to an embodiment of the present invention. Referring to FIG. 1, the system according to the embodiment may include a server 10 configured to provide a content sharing service, and a client 30 communicatively connected to the server 10 via a network 20 such as the Internet. Although FIG. 1 shows only one client 30, the server 10 may be communicatively connected to a plurality of clients 30.

The server 10 according to the embodiment of the present invention may provide a content sharing service; for example, the server 10 may delivery the posted contents such as a concert video to the client 30 along with other information necessary to provide the service. In the content sharing service, posted contents such as a concert video are released by the server 10. A user may operate the client 30 to access a desired one of the posted contents and view the desired content. As will be described later, the server 10 may have a function for displaying avatars of users and a message function for sending and receiving messages between users. The avatars of users may be displayed on the clients along with the contents; and the users can communicate with other users through the avatars. Thus, the server 10 may not only delivery posted contents but provide a virtual community space using avatars.

In response to a delivery request for a desired content from a client 30, the server 10 may cause a view including the requested content to be displayed on the client. The view to be displayed on the client 30 may include a content display region for displaying a delivered content and a background region for displaying information other than the content. In the embodiment of the present invention, the avatars and messages from users may be displayed in the background region.

The users can purchase virtual items that can be used in the service provided by the server 10. Part of the virtual items may be used for decorating the contents and the views thereof. Such items that can be used for decorating the contents and the views thereof may be herein referred to as “decorative items.” The users can purchase a decorative item while viewing a particular content or irrespective of viewing of contents. The users may operate their own clients 30 to send to the server 10 a display request for causing an item (also referred to as “a display item”) selected from the purchased decorative items to be displayed in the view. The server 10 according to an embodiment of the present invention can insert an image of the display item into the view in accordance with the display request. The display item may be displayed in, e.g., the background region of the view so as not to interfere the content displayed.

Next, the architecture of the server 10 according to an embodiment will be described. As shown, the server 10 according to an embodiment of the present invention may include a processor 11, a main memory 12, a user I/F 13, a communication I/F 14, and a storage 15. These components may be electrically connected to each other via a bus not shown. The processor 11 may load an operating system and various programs for providing the content sharing service including contents into the main memory 12 from the storage 15, and may execute commands included in the loaded programs. The main memory 12 may be used to store a program to be executed by the processor 11, and may be formed of, for example, a dynamic random access memory (DRAM).

The user I/F 13 may include, for example, an information input device such as a keyboard or a mouse for receiving an input from an operator, and an information output device such as a liquid crystal display for outputting calculation results of the processor 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the client 30 via the network 20.

The storage 15 may be formed of, for example, a magnetic disk drive. The storage 15 may store contents and background images constituting the view to be delivered to the client 30. The contents may be, e.g., video contents such as concert videos and recorded videos; but the types of the contents applicable to the present invention are not limited specifically. The contents may be stored in a predetermined file format in accordance with the type of the contents. For example, a video may be stored in a known format such as WMV format or QuickTime format. In an embodiment of the present invention, the storage 15 may store contents posted by general users (viewer of the contents) and contents posted by content providers (e.g., professional singers or entertainment production offices) previously authorized by an administrator of the server 10 to post the contents. The quality of the contents delivered can be maintained by previously examining the posting users.

The storage 15 may further store programs such as an operating system and various programs for delivering the view including contents. The storage 15 may also store various data such as messages posted by a user in connection with a content, image files of items, and image files of avatars, in association with the contents. The various data such as messages, image files of items, and image files of avatars may be used for generating a view to be displayed on the client 30. The various data that may be stored on the storage 15 may also be stored on a storage (e.g., a storage 25) or a database server that is physically separate from the server 10.

In an embodiment of the present invention, the server 10 may be a web server for communicating with the client 30 in HTTP and managing a web site including a plurality of hierarchical web pages. The web pages may include a top page for the service, a page for delivering contents, a page for setting accounts, a page for posting contents, and other various web pages related to the content sharing service. The server 10 may send the web pages (or the HTML data for displaying the web pages) constituting the web site to a client 30 in response to a request from the client 30.

In another embodiment of the present invention, an application program may be executed on the client 30 in an execution environment such as an OS or middleware, such that the application program and the server 10 may cooperate with each other to provide the content sharing service. The application program may be stored on, e.g., a storage 15 or a storage 25 and downloaded onto the client 30 in response to a request from the client 30. The application programs may include, on execution on the client 30, instruction sets for processing data provided by the server 10 and various data such as image data referred to when the instruction sets are executed.

Thus, the server 10 may manage a web site and deliver web pages constituting the web site in response to a request from the client 30, thereby providing the content sharing service. Further, the server 10 according to another embodiment of the present invention may cooperate with an application program executed on the client 30 to provide the content sharing service. Briefly, the server 10 may also include additional functions for providing the content sharing service, such as a function for implementing a player authentication process and a user charging process.

An architecture of the client 30 will be described below. In an embodiment, the client 30 may be a desired information processing device including an application execution environment for executing an application including a web browser. Non-limiting examples of the client 30 may include mobile phones, smartphones, tablet terminals, personal computers, electronic book readers, and game consoles.

As shown, the client 30 according to an embodiment of the disclosure may include a processor 31, a main memory 32, a user interface (I/F) 33, a communication I/F 34, and a storage 35, and these components may be electrically connected to one another via a bus (not shown).

The processor 31 may load various programs such as an operating system into the main memory 32 from the storage 35, and may execute commands included in the loaded programs. The main memory 32 may be used to store a program to be executed by the processor 31, and may be formed of, for example, a dynamic random access memory (DRAM).

The user I/F 33 may include an information input device for receiving inputs from the user and an information output device for outputting an operation result of the processor 31; and the user I/F 33 may include a display device such as a liquid crystal display having a touch screen. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the network 20.

The storage 35 may comprise, for example, a magnetic disk drive or a flash memory and store various programs such as an operating system. When receiving an application program from the server 10 via the communication I/F 34, the storage 35 may store the received application program.

The client 30 may include, for example, browser software for interpreting an HTML file (HTML data) and rendering a screen; this browser software may enable the client 30 to interpret the HTML data fetched from the server 10 and render web pages corresponding to the received HTML data. Further, the client 30 may include plug-in software (e.g., Flash Player distributed by Adobe Systems Incorporated) embedded into browser software; therefore, the client 30 can fetch from the server 10 a SWF file based on commands embedded in HTML data and execute the SWF file by using the browser software and the plug-in software.

When the HTML data contains a script, the browser software may execute the script and perform a process in accordance with the instruction of the script. For example, if the script in the HTML data refers to a file of the content stored on the storage 15 of the server 10, the browser software may fetch the file referred to from the server 10 and embed the fetched content into the web page for rendering.

The web page fetched from the server 10 may include information indicating a list of contents that can be delivered from the server 10. A user may operate the client 30 to select a desired content from the list and view the selected content on the client 30.

In the client 30, an application program may be launched in accordance with the operation by the player and executed on a platform implemented on the client 30. When the application program is executed on the client 30, for example, the application program may communicate with the server 10 and fetch information necessary for the content sharing service, such as information indicating a list of contents that can be delivered. In the case of using this application, similar to the case of using the web page, a user may operate the client 30 to select a desired content from the list and view the selected content on the client 30.

As described above, the user of the client 30 can receive a desired content delivered from the server 10 and can receive other various services included in the content sharing service,

The functions implemented by the computer program modules executed on the server 10 and the client 30. The processor 11 of the server 10 and the processor 31 of the client 30 may execute various computer program modules described below, so as to implement the content sharing service provided to the users of the client 30.

As shown in FIG. 1, computer program modules executed by the processor 11 of the server 10 may include a content management module 41, a purchase history management module 42, a reception module 43, a ranking generation module 44, a display position determination module 45, and a display control module 46. The computer program modules executed by the processor 31 of the client 30 may include a display module 61, an input receiving module 62, and a sending module 63.

A part or all of the modules provided on the server 10 shown in FIG. 1 may also be executed by the processor 31 of the client 30 or a processor of other devices; and a part or all of the modules provided on the client 30 may also be executed by the processor 11 of the server 10 or a processor of other devices. For example, when a storage storing contents is provided on a server other than the server 10, the content management module may also be provided on the other server. The processor 11 and the processor 31 can execute modules other than the modules shown in the drawing.

The computer program modules executed by the processor 11 of the server 10 will be described below. The content management module 41 according to an embodiment of the disclosure may record the contents posted by the posting users in such a manner that these contents can be delivered to the client 30. The posted contents may be stored on, for example, the storage 15. Upon posting of a content, the content management module 41 according to an embodiment of the present invention may issue a content ID that identifies the content and record the content ID in a posting user management database (not shown) in association with the posting user ID that specifies the posting user of the content.

The purchase history management module 42 according to an embodiment of the present invention may manage the purchase history of various items such as decorative items for each user of the content sharing service provided by the server 10. As described above, the users can purchase a decorative item while viewing a particular content or irrespective of viewing of contents. The purchase history management module 42 may manage the purchase quantity and/or the purchase amount for each purchased item. The decorative items can be purchased with, e.g., virtual currency or points circulated in the service. The purchase history management module 42 may also manage, for each user, the consumed currency or the consumed points used by the user for purchasing the items. The term “purchase amount” used herein may include, not only the purchase amount paid for items with real currency, but also the purchase amount paid for items with virtual currency and the points available in the content sharing service that are consumed for purchasing items. As described above, the users can purchase items free of charge (that is, “obtain” the items).

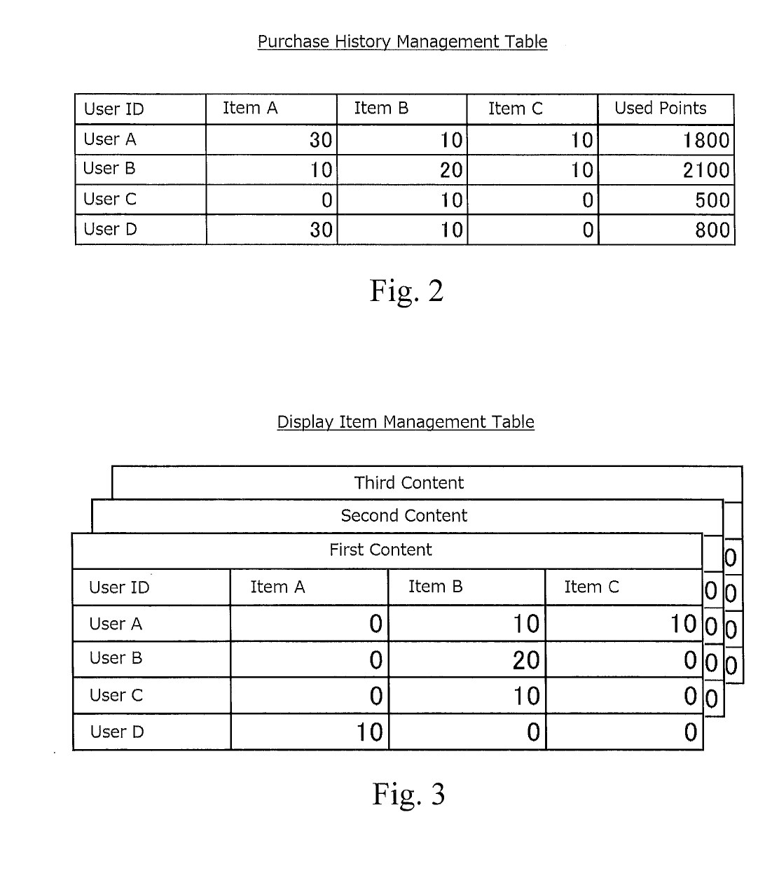

The above-described purchase history information indicating the purchase history of items for each user may be managed using, e.g., a purchase history management table. FIG. 2 shows an example of purchase history management table used in the embodiment of the present invention. As shown, the purchase history management table may manage, in association with the user name or user ID of each user, the purchase quantity of the decorative items (items A to C) purchased by the user. The purchase history management table may also manage the total of points used for purchasing the items (“used points”). In the embodiment shown in FIG. 2, one item A may be purchased for 10 points, one item B may be purchased for 50 points, and one item C may be purchased for 100 points. For example, user A purchased 30 items A, 10 items B, and 10 items C for 1,800 points (30×10+10×50+10×100).

The purchase history management table shown in FIG. 2 is a mere example. The purchase history management module 42 may store various information on purchase history of items for each user. When an item is purchased for decorating a particular content (or a view including the content), the item may be managed in association with the content. For example, the purchase history management table shown in FIG. 2 may be prepared for each content, such that the purchase history of each user can be managed in association with the content. In an embodiment of the present invention, when an item is purchased while viewing a particular content, the purchase history information related to the purchase of the item may be managed in association with the content. In the table shown in FIG. 2, three types of items, items A to C, are managed; but the number of items that can be managed may be set desirably.

The user viewing the particular content may select a display item to be displayed along with the content from the purchased items and send to the server 10 a display request for requesting that the selected item be displayed along with the content. The display request may be received by the reception module 43 in the server 10. The reception module 43 according to an embodiment of the present invention is configured to receive the display request for the display item selected from the items purchased by the user. In an embodiment of the present invention, the display request from the user may include identification information (an item ID) that identifies the display item to be displayed and the number of the items to be displayed The reception module 43 can specify the display item for which the user made the display request based on the item ID included in the display request sent from the user.

The reception module 43 according to an embodiment of the present invention may also manage the display item for which the user made the display request based on the display request sent from the user. Information related to the display item requested by the user for display may be managed using, e.g., a display item management table. FIG. 3 shows an example of display item management table used in the embodiment of the present invention. As shown, the display item management table may manage, in association with the user name or user ID of each user, the number of the display items for which the user made the display request (the items A to C). As described above, each user can select a display item from the decorative items purchased.

In the embodiment shown in FIG. 2, user A has purchased 30 items A, 10 items B, and 10 items C. For example, when user A sends a display request to request that 10 items B and 10 items C among the items above be displayed along with a first content, the display item management table may contain data as shown in FIG. 3. More specifically, user A may select 10 items B and 10 items C as display items; a display request indicating the item IDs and the numbers of these items may be received by the reception module 43; and the record for user A in FIG. 3 may be updated as shown in FIG. 3 based on the display request. The display item management table may be referred to by a display control module 46 (described later) in specifying the display item to be displayed in the view including the content.

A ranking generation module 44 according to an embodiment of the present invention may refer to the display item management table and generate a ranking of users in the descending order of the purchase quantity or purchase amount (used points) of a display item for which the users made the display requests. The ranking may be generated, e.g., for each content. When the ranking is related to the first content, the ranking generation module 44 may refer to the display item management table for the first content, specify the display item for which the users made the display requests, and calculate the used points used for purchasing the display item for each user. Suppose that one item A may be purchased for 10 points, one item B may be purchased for 50 points, and one item C may be purchased for 100 points, as with the example described above. In the embodiment shown in FIG. 3, the display items for which user A made a display request had been purchased for 1,500 points (10×50+10×100); the display items for which user B made a display request had been purchased for 1,000 points (20×50); the display items for which user C made a display request had been purchased for 500 points (10×50); and the display items for which user D made a display request had been purchased for 100 points (10×10). Therefore, the ranking may be in the order of user A, user B, user C, and user D.

The display position determination module 45 according to an embodiment of the present invention may determine the display positions of the avatars of users based on display requests from the users. The display position determination module 45 may determine the display positions of the avatars of the users such that, e.g., as the purchase quantity or purchase amount of the display item is larger, the avatars of such users are displayed closer to the display position of the content. The purchase quantity and the purchase amount (or used points) required for purchasing the display items may be determined by, e.g., referring to the display item management table shown in FIG. 3.

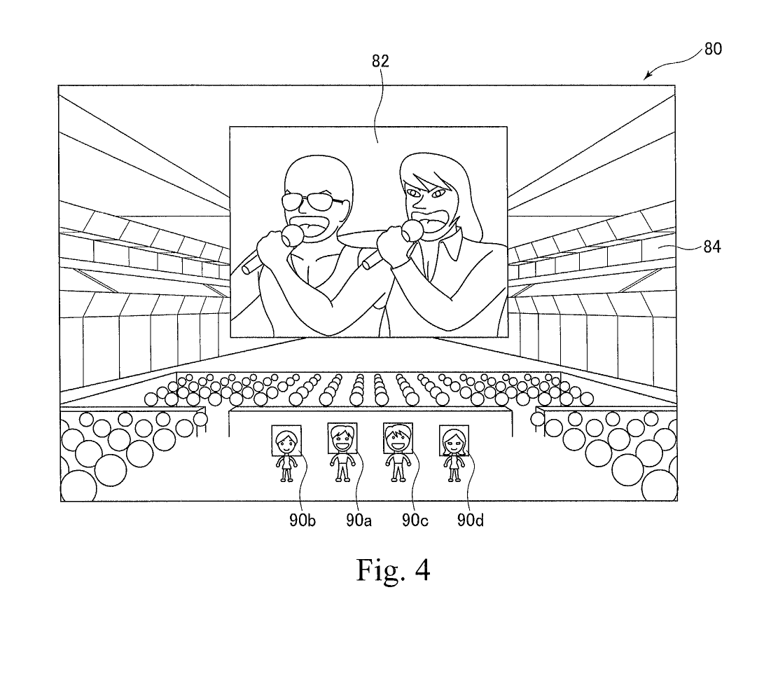

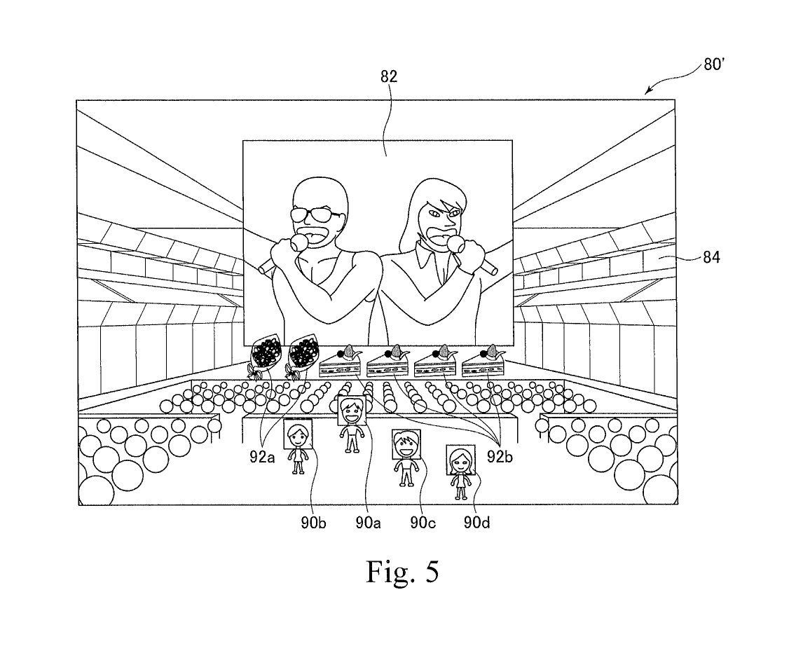

The display positions of the avatars will be described with reference to FIGS. 4 and 5. FIGS. 4 and 5 show examples of a view displayed on the display of the client 30 according to an embodiment of the present invention. FIG. 4 shows the view 80 immediately after the delivery of the content is started. The view 80 immediately after the delivery is started may include a concert video 82 corresponding to a content delivery request from the client 30, a background image 84, and avatar images 90a to 90d corresponding to users A to D, respectively. The avatar images 90a to 90d may be positioned at predetermined default positions, and the distances from the concert video 82 to the avatar images in the virtual space may be substantially equal. FIG. 5 shows the view 80′ after each of users A to D viewing the concert video 82 in the view 80 of FIG. 4 has made a display request for items. The positions of the avatar images 90a to 90d in the view 80′ are different from those in the view 80. In addition, the images 92a and 92b of the display items for which the users made display requests are displayed.

The positions of the avatar images 90a to 90d in FIG. 5 may be determined by the display position determination module 45. More specifically, the display position determination module 45 according to an embodiment of the present invention may determine the display positions of the avatars 90a to 90d based on the display requests from users A to D such that a user among users A to D purchasing a larger quantity of display items or consuming a larger amount for purchasing the display items can have an avatar thereof displayed at a position closer to the display position of the concert video 82.

For example, suppose that while viewing the concert video 82 (the first content), user A makes a display request for displaying 10 items B and 10 items C, user B makes a display request for displaying 20 items B, user C makes a display request for displaying 10 items B, and user D makes a display request for displaying 10 items A, the display item management table for the first content may be updated as shown in FIG. 3. In the example of FIG. 3, more points are used in the descending order of user A, user B, user C, and user D, as described above. As shown in FIG. 5, the display position determination module 45 may determine the display positions of the avatars such that the avatar image 90a of user A who spent the largest purchase amount (used points) for purchasing the display items is the closest to concert video 82, whereas the avatar image 90d of user D who spent the smallest purchase amount (used points) for purchasing the display items is the farthest from the concert video 82. In FIG. 5, the avatar images 90a to 90d are displayed at the display positions thus determined.

When users A to D repeatedly make display requests, the display item management table shown in FIG. 3 may be updated as required Based on the updated display item management table, the positions of the avatar images 90a to 90d may be determined The display position determination module 45 according to an embodiment of the present invention may be configured to determine the display positions of the avatar images each time a display request is received from a user viewing a particular content (or each time the display item management table is updated). The display position determination module 45 according to another embodiment of the present invention may be configured to determine the display positions of the avatars of the users based on display requests made within a predetermined period (e.g., one hour) after the delivery of the content is started. The display position determination module 45 according to still another embodiment of the present invention may be configured to determine the display positions of the avatars of the users based on display requests made within a given calculation period during delivery of the content (e.g., the period of 30 minutes from the point 30 minutes after the viewing is started). The calculation period for a particular content may be determined either by the provider of the content or by the administrator of the server 10.

The display position determination module 55 according to another embodiment of the present invention may be configured to determine the display positions of the avatar images of the users based on the purchase history of the users. The display position determination module 45 may determine the display positions of the avatars of the users such that, e.g., as the purchase quantity or purchase amount of the item is larger, the avatars of such users are displayed closer to the display position of the content. The purchase quantity and the purchase amount (or used points) required for purchasing the items may be determined by, e.g., referring to the purchase history management table shown in FIG. 2. In the example shown in FIG. 3, more points are used for purchasing the items in the descending order of user B, user A, user D, and user C; therefore, the avatar 90b of user B may be displayed closest to the content, whereas the avatar 90c of user C may be displayed farthest from the content.

In response to a delivery request for a particular content from the client 30, the display control module 46 according to an embodiment of the present invention may cause the client of the user viewing the content to display a view including the content, the background image, the images representing the avatars of the users viewing the content, and the images representing the display items.

More specifically, upon receiving a delivery request for a content, the display control module 46 according to an embodiment of the present invention may read out the content corresponding to the delivery request from the storage 15. Then, the display control module 46 may cause the client 30 of each user to display the view in which the content display region includes the content read out from the storage 15, the background region includes a predetermined background image, and this background image includes the display items for which the users made display requests and the avatars of the users. The avatar images of the users may be displayed at display positions determined by the display position determination module 45. The display control module 46 may refer to the display item management table, specify display items for which the display request was made in relation to the content for which the delivery request was made, and insert images of the specified display items into a predetermined position in the view. The display control module 46 may generate HTML data which may specify by the EMBED tag the URI indicating the storage site of the concert video requested for delivery, specify by the body element the URI indicating the storage site of the image file of the background image specified based on posting user evaluation information, specify by the img element the URI indicating the storage site of the image files of the display items, and specify by the OBJECT tag the flash images representing the avatars of the users. Then, the display control module 46 may send the HTML data to the client 30 such that the client 30 displays a view including the content requested for delivery, the background image, the display items, and the avatar images of the users. The display control module 46 according to an embodiment of the present invention may insert into the view the information indicating the ranking generated by the ranking generation module, in addition to the above information. When the display positions of avatars are determined based on the display requests made within a predetermined period (e.g., one hour) after the delivery of the content is started, the view may include information indicating the elapsed time after the delivery of the content is started or the ending time of the predetermined period.

In an embodiment of the present invention, the display module 61 of the client 30 may display the view including the content, the background image, the display items, and the avatars on the display of the client 30 (or the display of an external device), in accordance with the control by the display control module 46 of the server 10. For example, the display module 61 may analyze the HTML data received from the display control module 46, obtain the content, the background image, the images of the display items, and the avatar images, display the obtained content in the content display region, display the obtained background image as a background of the view, and superimpose the images of the display items and the avatar images on the background image.

The input receiving module 62 according to an embodiment of the present invention can receive various instructions from the user. The user of the client 30 may perform a predetermined operation (e.g., tap or double tap) on the region of a touchscreen provided on the client 30 where an operation object (e.g., an operation button) is displayed, so as to input an instruction associated with the object. The various instructions from the user may include an instruction to select an item to be purchased, an instruction to confirm a purchase, an instruction to select a display item, and an instruction to send a display request.

The messages indicating various instructions from the player received by the reception module 62 may be sent to the server 10 via the network 20 by the sending module 63 according to an embodiment of the present invention. As stated above, the server 10 may perform various processes such as calculation of posting user evaluation information based on the received messages.

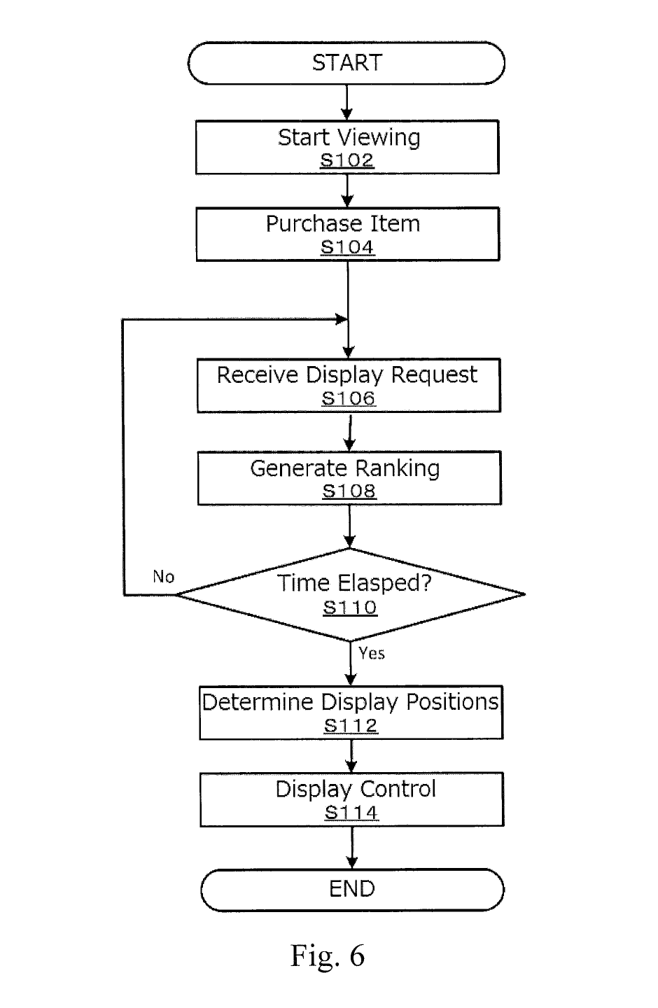

Referring next to FIG. 6, the process flow from start of viewing the content to determination of the posting user evaluation information will be described below in accordance with an embodiment of the present invention. First, in step S102, the user of the client may access the server providing the content sharing service and start viewing a desired content. As shown in FIG. 4, the client may display, e.g., a view including the content requested for delivery, a background image, and avatar images positioned at the default positions thereof.

Next, in step S104, the user may operate the client to purchase an item (e.g., a decorative item). When the information specifying the purchased item (e.g., an item ID) is sent to the server, the server may manage for each user the purchase history information indicating the type and quantity of the items purchased by the user. The purchase history information may be managed by the purchase history management module 42 using the purchase history management table shown in FIG. 2.

Next, in step S106, the user viewing the particular content may select a display item to be displayed along with the content from the purchased items and send to the server a display request for requesting that the selected item be displayed along with the content. The display request may be received by, e.g., the reception module 43 in the server. Information related to the display item requested for display may be managed by the reception module 43 using, e.g., a display item management table shown in FIG. 3.

Next, in step S108, a ranking of users may be generated in the descending order of the purchase quantity or purchase amount (used points) of display items for which the users made the display requests. This ranking may be generated by, e.g., the ranking generation module 44 using the display item management table shown in FIG. 3.

Next, in step S110, it is determined whether a predetermined time period has elapsed after the delivery of the content is started. If the predetermined time period has not elapsed, the process may return to step S106 where another display request may be received. If the predetermined time period has elapsed, the process may return to step S112 where the display positions of the avatars of the users may be determined In step S112, the display positions of the avatars of the users may be determined based on the display requests from the users. The display positions of the avatars may be determined by, e.g., the display position determination module 45. The display positions of the avatars of the users may be determined such that, e.g., as the purchase quantity or purchase amount of the display item is larger, the avatars of such users are displayed closer to the display position of the content.

Next, in step S114, the view including the content, the background image, the avatar images of the users viewing the content, and the images of the display items may be sent to the client of the user viewing the content. The display items may be determined based on the display request received in step S106. The images representing the avatars of the users may be displayed at the positions determined in step S112. This step of displaying the view may be performed by, e.g., the display control module 46. The client may now display, e.g., the view shown in FIG. 5.

As described above, according to various embodiments of the present invention, the display positions of the avatars of the users may be determined in accordance with the display requests for the display items selected from the items purchased by the users. In a particular embodiment of the present invention, the display positions of the avatars of the users may be determined such that, e.g., as the purchase quantity or purchase amount of the display item is larger, the avatars of such users are displayed closer to the display position of the content. Therefore, the users can grasp which user made more display requests, and furthermore, which user purchased more items. Thus, the rivalry between the users may urge the users to purchase items.

The procedures described herein, particularly those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention. For example, step S108 in FIG. 6 for generating a ranking may be omitted. Further, step S110 for determining whether or not a predetermined time period has elapsed may be omitted. In the case where step S110 is omitted, when a display request for an item is received from a user, the display position determination module 55 may determine the display positions of the avatars of the users based on the display request and the display requests received from other users.

In an embodiment of the present invention, the points (contribution points) of the users may be calculated for each content in accordance with the contribution of the users to the content, and the display positions of the avatars of the users may be determined based on the contribution points. The contribution points of a user may be provided to the user, e.g., when the user introduces a content on a social network site, or when a user other than the user visits a content introduced on the social network site, that is, when the user (contribution user) performs various activities considered to contribute to increase of the number of times of viewing the particular content. Such calculation of the contribution points may be performed in accordance with various calculation logic by, e.g., a contribution point calculating module (not shown) executed on the processor 11 of the server 10.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

### LIST OF REFERENCE NUMBERS

10 server

11, 31 processor

15, 25, 35 storage

30 client

41 content management module

42 purchase history management module

43 reception module

44 ranking generation module

45 display position determination module

46 display control module

61 display module

62 input receiving module

63 sending module

1. A system comprising one or more computer processors for executing a computer program to provide a content to each of a plurality of users,
wherein the computer program comprises:
a reception module configured to receive from each of the plurality of users a display request for a display item selected from items purchased by the user;
a display position determination module configured to determine display positions of avatars of the plurality of users based on the display requests from the users; and
a display control module configured to cause a client of each of the plurality of users to display a view including the content, an image representing the display item, and images representing the avatars of the users such that the avatars of the users are displayed at the display positions determined by the display position determination module.

2. The system of claim 1, wherein the display position determination module determines the display positions of the avatars of the users such that as a purchase quantity or purchase amount of the display item is larger, the avatars of such users are displayed closer to the display position of the content.

3. The system of claim 1, wherein the computer program further comprises a ranking generation module configured to generate a ranking of the plurality of users related to a purchase quantity or purchase amount of the display item; and
the display image further includes information indicating the ranking.

4. The system of claim 1 wherein the display position determination module determines the display positions of the avatars of the users based on the display requests made within a predetermined time period.

5. The system of claim 4, wherein the view includes information indicating an ending time of the predetermined time period.

6. A system comprising one or more computer processors for executing a computer program to provide a content to each of a plurality of users,
wherein the computer program comprises:
a display position determination module configured to determine display positions of avatars of the plurality of users based on purchase history of items of the users; and
a display control module configured to cause a client of each of the plurality of users to display a view including the content and images representing the avatars of the users such that the avatars of the users are displayed at the display positions determined by the display position determination module.

7. A method for providing a content to each of a plurality of users, the method comprising the steps of:
receiving from each of the plurality of users a display request for a display item selected from items purchased by the user;
determining display positions of avatars of the plurality of users based on the display requests from the users; and
causing a client of each of the plurality of users to display a view including the content, an image representing the display item, and images representing the avatars of the users such that the avatars of the users are displayed at the display positions determined by the step of determining the display positions.
